(19) United States
(12) Patent Application Publication
(10) Pub. No.: US 2017/0140136 A1
(43) Pub. Date: May 18, 2017

(54) IDENTITY VERIFICATION

(71) Applicant: VATOSCAN (PTY) LTD, Rosebank (ZA)

(72) Inventor: John Kininmonth KANE, Johannesburg (ZA)

(73) Assignee: VATOSCAN (PTY) LTD, Rosebank (ZA)

(21) Appl. No.: 15/319,108

(22) PCT Filed: Jul. 29, 2015
(86) PCT No.: PCT/IB15/55721

§ 371 Date: Dec. 15, 2016

(30) Foreign Application Priority Data
Jul. 29, 2014 (ZA) 2014/05571

(51) Int. Cl. G06F 21/31

(52) U.S. Cl. CPC G06F 21/31

(57) ABSTRACT

A method of associating a person with a particular set of data, which method includes, digitally capturing an image of a trusted document on which the identity of a person is represented on a capturing device, capturing data with which the person is to be associated on the capturing device, transmitting the digitized document in combination with the captured data via a computer network from the capturing device to a remote receiver.

### FIELD OF THE INVENTION

This invention relates to identity verification. In particular, the invention relates to a method of associating a person with a particular set of data and to a personal data association system.

### BACKGROUND OF THE INVENTION

Processes and systems for the verification of persons is known to the inventor. However, as business expands into remote geographical areas where sophisticated communication infrastructure is not available, the need for identity verification in remote areas or in locations where communication infrastructure is not readily available has arisen.

The present invention aims to provide a stand-alone identity verification method and system that can be operated with a minimum amount of training to users.

### SUMMARY OF THE INVENTION

According to one aspect of the invention, there is provided a method of associating a person with a particular set of data, which method includes

digitally capturing an image of a trusted document on which the identity of a person is represented on a capturing device;

capturing data with which the person is to be associated on the capturing device; and

transmitting the digitized document in combination with the captured data via a computer network from the capturing device to a remote receiver.

The method may include, on the capturing device, evaluating the digitized document according to predefined evaluation criteria.

The method may include storing the captured data in association with the person identified on the digitized document if the predefined evaluation criteria are met on the capturing device.

The computer network may be a mobile telephone network, the Internet, or the like.

The method may include the step of requesting a person to accept certain conditions upon associating the person with a particular set of data. For example, a person may be requested to accept legal terms and conditions associated with a particular service for which a person is applying, such as a mobile telephone SIM card representing certain mobile telephone services for which a person is applying.

Furthermore, if there is a requirement that a person must present himself/herself for identity verification purposes, the digital image may be an image of the person's face, which can then be verified against other data. For example, if a person has to be identified against his/her identity document the method may include capturing the identity document of the person in combination with a head-and-shoulders image of the person. Therefore, the step of capturing an image may include capturing any document or subject, which can be optically represented.

The method may include the step of verifying the identity of an operator of the remote capturing device.

The method may further include

receiving in digitized format a captured image of a trusted document on which the identity of a person is represented on a server;

receiving data with which the person is to be associated on the server;

evaluating the digitized document according to predefined evaluation criteria; and

storing the captured data in association with the person identified on the digitized document if the predefined evaluation criteria is met.

The trusted document may be any document on which the identity of a person is represented such as an identity book, driver's license, social security card, or the like, issued by a government agency. Furthermore, in an application where specific details of a person are to be verified, such as residency, the trusted document may be a document that provides proof of residence. The trusted document can thus be any document which confirms data that is to be associated with the person, such as Income Tax registration, voter's registration, or the like.

Capturing data with which the person is to be associated may include data related to a particular business transaction, such as the issuance of a Subscriber Identity Module (SIM) for use in a mobile telephone network, a transaction card, a pre-paid electricity card, or the like, all of which is to be uniquely associated with a person.

Evaluating the digitized document may include comparing the images of the digitized document with previous data, which the document purports to represent. If an image of a person is taken, the criteria may include comparing the image of the person with his/her image represented on a trusted document. For example and image of a person may be compared with his/her image on the trusted document. The predefined criteria may include any manual or automated comparison of data with the data, which is captured during the step of digitally capturing an image of a trusted document.

The method may include transmitting a message to a remote receiver reporting the outcome of the association process.

The invention extends to a personal data association system, which includes

a remote data capturing device, having imaging means for capturing and digitizing an image of a trusted document and having a mobile communications interface for transmitting the digitized document in combination with captured data which is to be associated with a person whose identity is to be verified;

a receiver, operable to receive the digitized document in combination with the captured data with which the person is to be associated;

a database having data fields to store data represented in the digitized document and captured data with which the person is to be associated.

The invention will now be described by way of a non-limiting example only, with reference to the following drawing.

### DRAWINGS

In the drawings:

FIG. 1 shows a personal data association system, in accordance with one aspect of the invention;

FIG. 2 shows a request to a mobile telephone service provider, which incorporates a method of associating a person with a particular set of data, in accordance with another aspect of the invention;

FIG. 3 shows a step preceding the step of digitally capturing an image of a trusted document, which forms part of the method of FIG. 2;

FIG. 4 shows another step preceding the step of digitally capturing an image of a trusted document, which forms part of the method of FIG. 2;

FIGS. 5 and 6 show examples of the step of digitally capturing an image of a trusted document on which the identity of a person is represented which forms part of the method of FIG. 2;

FIG. 7 shows the step of verifying the identity of an operator of the remote capturing device, which forms part of the method of FIG. 2;

FIGS. 8 and 9 show the step of evaluating the digitized document according to predefined evaluation criteria, which forms part of the method of FIG. 2; and

FIG. 10 shows the step of requesting a remote receiver to accept certain conditions upon associating the person with a particular set of data.

### DETAILED DESCRIPTION OF AN EMBODIMENT OF THE INVENTION

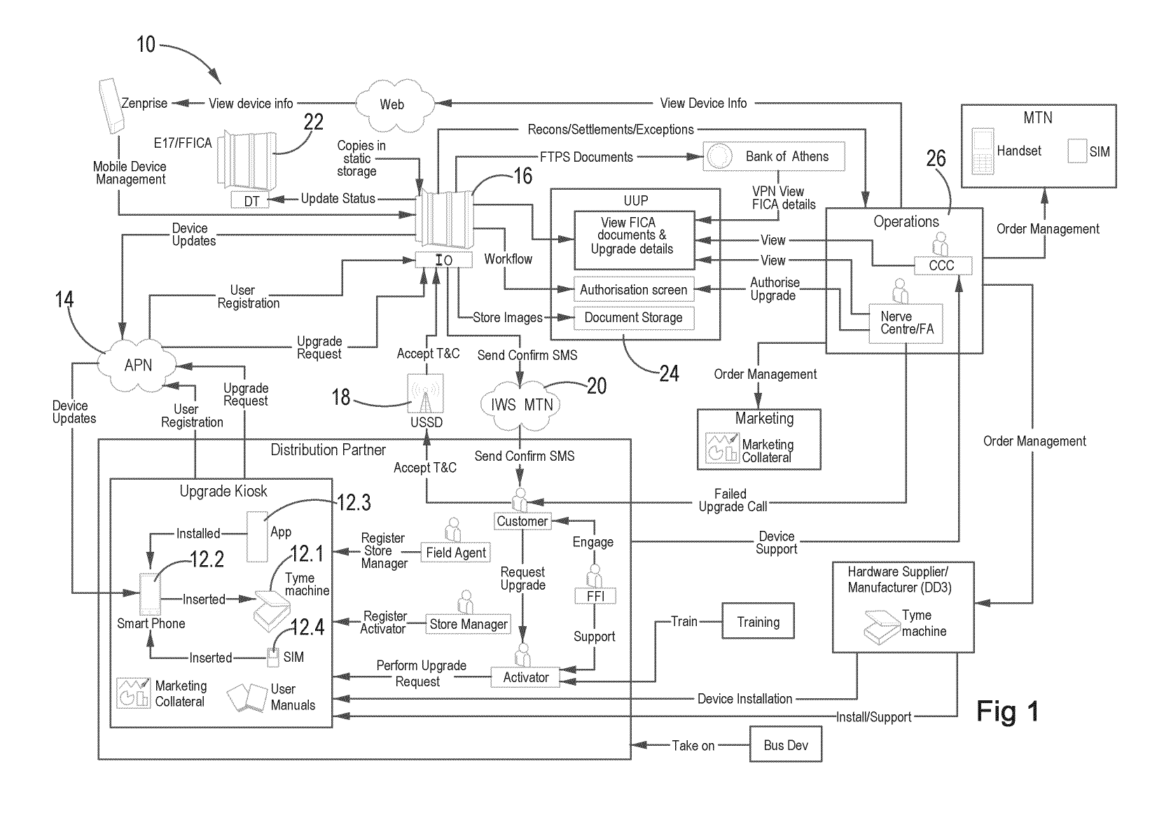

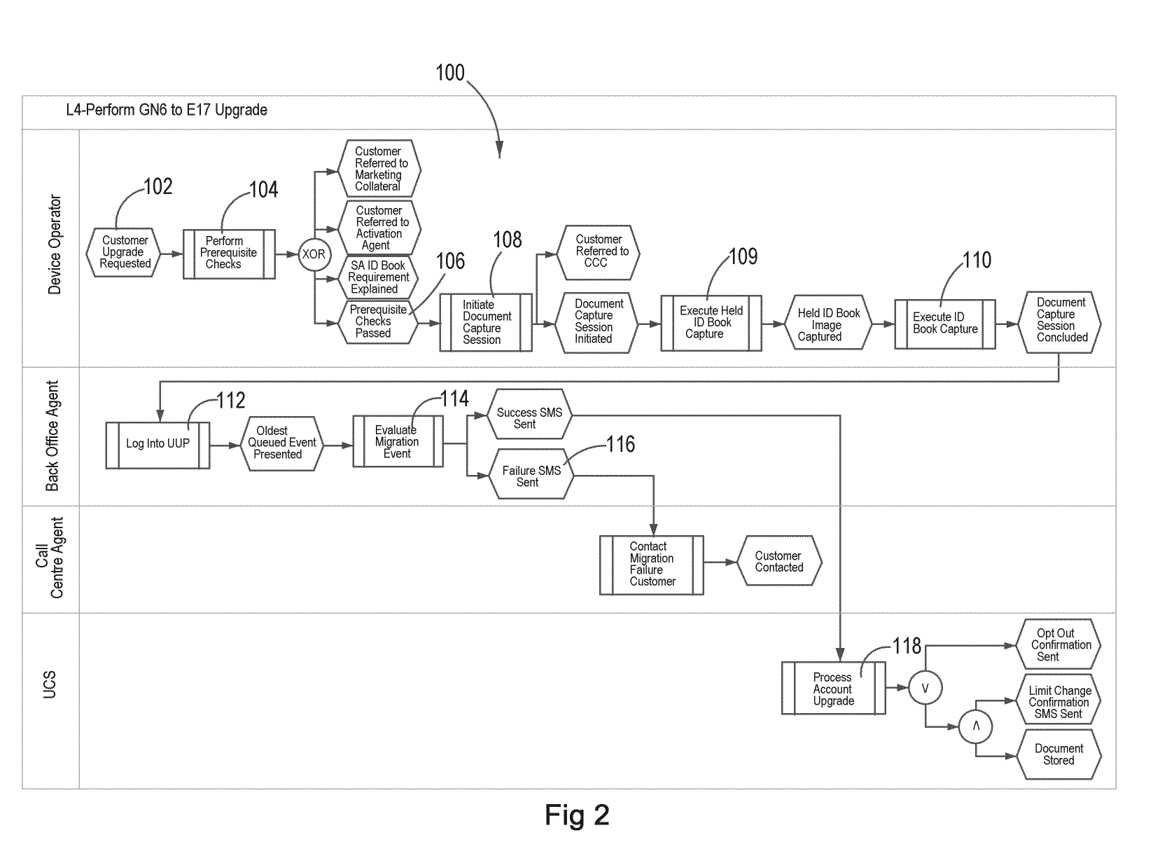

In FIG. 1 a personal data association system 10 is shown together with certain steps in a method of associating a person with a particular set of data (which will be described later in detail with reference to FIGS. 2 to 10.

The system 10 includes a remote data-capturing device 12, in the form of a so called upgrade kiosk. The remote data-capturing device 12 comprises of a specially designed mobile communications device mount 12.1 and a mobile telephone 12.2 that is receivable into the mount 12.1. The mobile telephone 12.2 is installed with an application 12.3 that facilitate part of the method of associating a person with a particular set of data. The mobile telephone 12.2 is also installed with a Subscriber Identity Module 12.4, which is uniquely registered onto a mobile telephone network.

The mobile telephone 12.2 is connected to a mobile telephone General Packet Radio Service (GPRS) network gateway 14, which is connected to a data receiver, in the form of a server 16 and a database 22. The database 22 has data fields to store data represented in the digitized document and captured data with which the person is to be associated.

The server 12.6 is connectable to a person whose identity is to be verified via a Unstructured Supplementary Service Data (USSD) link 18 hosted by the mobile telephone network and with via a Short Message Service (SMS) facility 20 on the mobile telephone network. It is to be appreciated that the USSD link can be replaced with a GPRS link, a Wi-Fi link, or the like.

The server 16 is connected to an application 24, which has access to data stored on the database 22. The application 24 is accessed by a back office 26 where the digitized document is evaluated according to predefined evaluation criteria.

The other components in the personal data association system shown in FIG. 1 is for a particular application where a person's personal details are to be linked with a particular SIM card on a mobile telephone network and will not be described in further details in this example.

In FIG. 2 a request 100 to associate a mobile telephone user's personal data with a particular SIM is illustrated as part of a method of associating a person with a particular set of data, in accordance with another aspect of the invention. At 102 a request to perform the association is received and at 104 a number of predefined checks on the transaction is performed. If the checks are successful at 106 a document capturing session is initiated at 108. In this example a user is required at 109 to hold up an identity document in from of him/her and a digital image is created. The user is further required to submit the document for imaging at 110. At 112 a service agent logs onto the application 24 and the request is evaluated according to a predefined set of evaluation criteria at 114. If the evaluation is unsuccessful a message is sent to a user at 116. If the evaluation was successful a contracting process is initiated at 118.

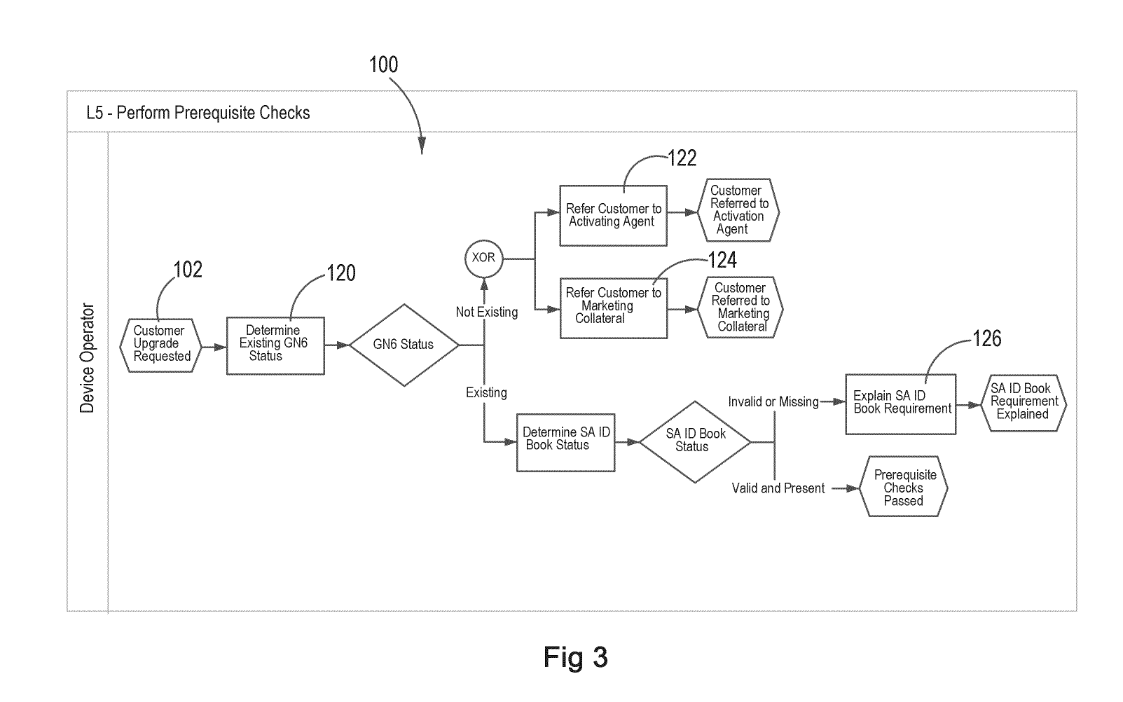

In a particular example in which an association is requested to associate a SIM to a user, the prerequisite test performed at 104 (in FIG. 2) is explained in more detail in FIG. 3. At 102 a request is received to perform the association with the user. At 120 the user status on the mobile telephone network is determined. If the user is not an existing user at 120, the user can be referred to an agent at 122 or a marketer 124. If the user is an existing user 124, the requirements for collecting information from a user's Identity book is explained at 126.

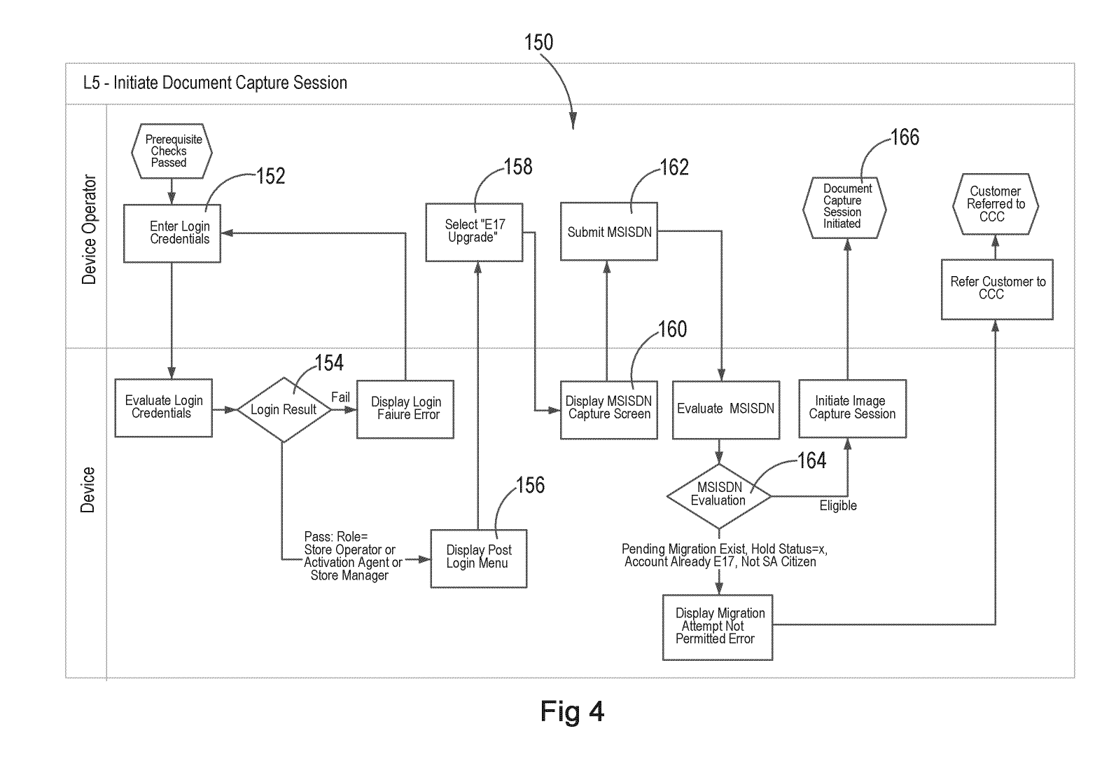

Once a decision has been taken to capture information from a user's ID book, the initiation of a document capturing session 150, shown in FIG. 4 is initiated.

At 152 an operator's login details is requested. If the login details can be validated at 154 a confirmation screen is displayed at 156. The operator has the opportunity to select the particular association that is to be performed at 158 a request to provide the Mobile Subscriber Integrated Services Digital Network (MSISDN) number is displayed at 160. The MSISDN is supplied by the operator at 162, which is evaluated at 164. If the MSISDN is successfully evaluated the document capturing session is proceeded to at 166.

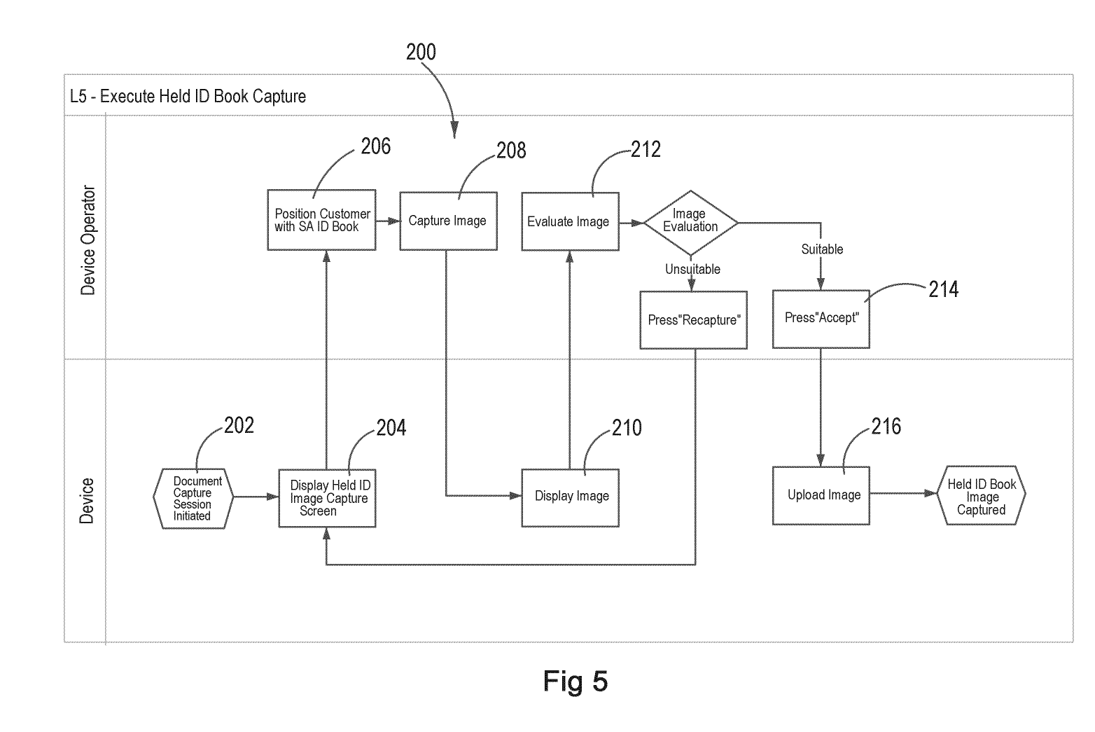

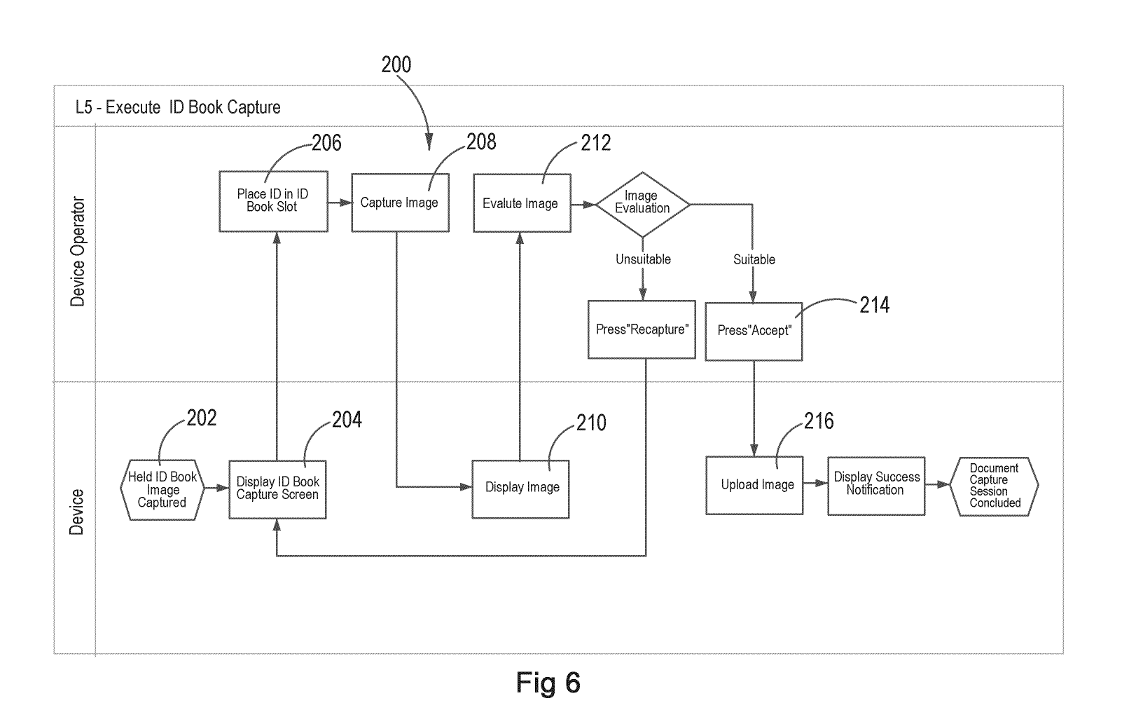

FIGS. 5 and 6 describe the same process for two types of documents and the same reference numerals will be used for the same steps. A document capturing session 200 is initiated at 202. At 204 a user is prompted to present a document, which is the presented at 206. At 208 and image is captured, which is displayed at 210 and evaluated at 212. If the image was successfully captured the operator is prompted to confirm success at 214 and the document is uploaded to the database 22 at 216.

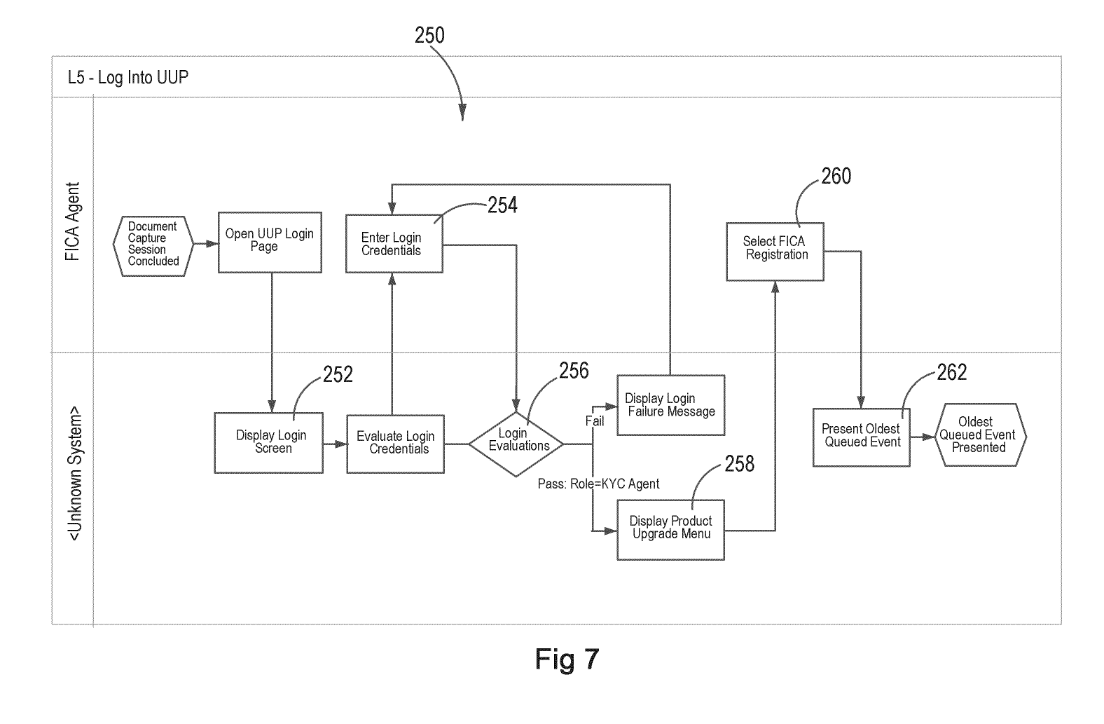

In FIG. 7 the step of verifying the identity of an operator of the remote capturing device and the initiation 250 of the association process is shown. An operator log onto the application 24 at 252, where after the login credentials are entered at 254. The operator's login credentials are evaluated at 256 and, if successful, a menu of available options is displayed at 258. When an operator selects a particular type of association that is to be performed at 260. A list of outstanding verifications are presented with the oldest verification request being presented first at 262.

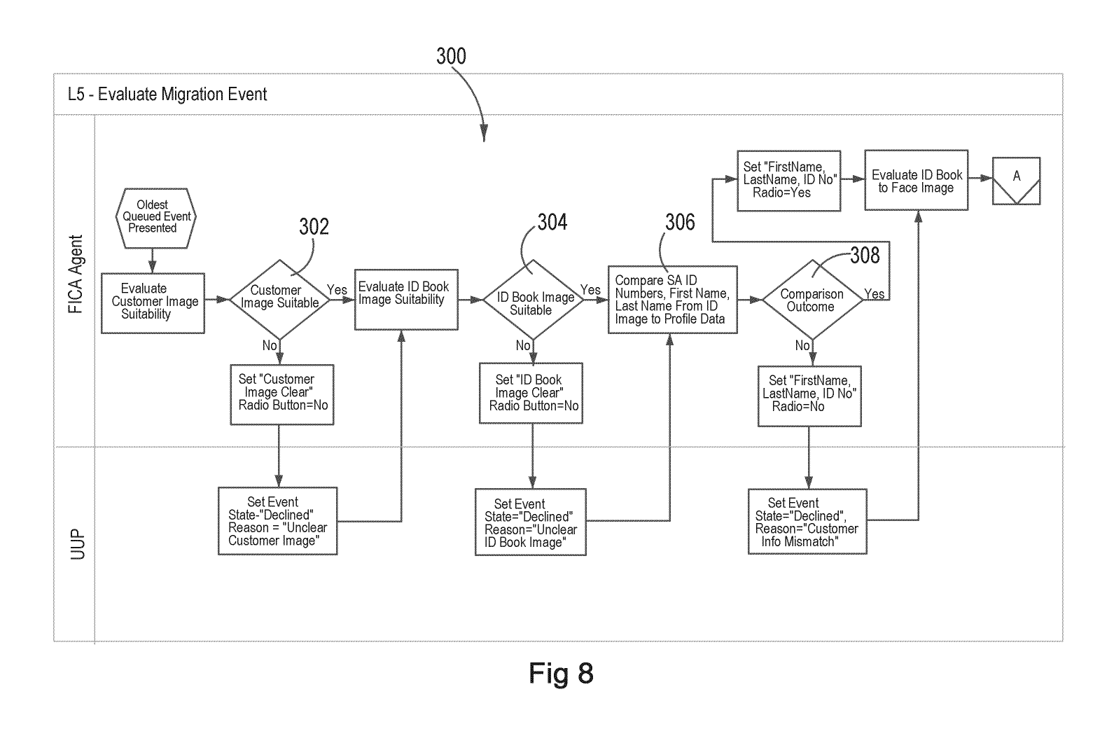

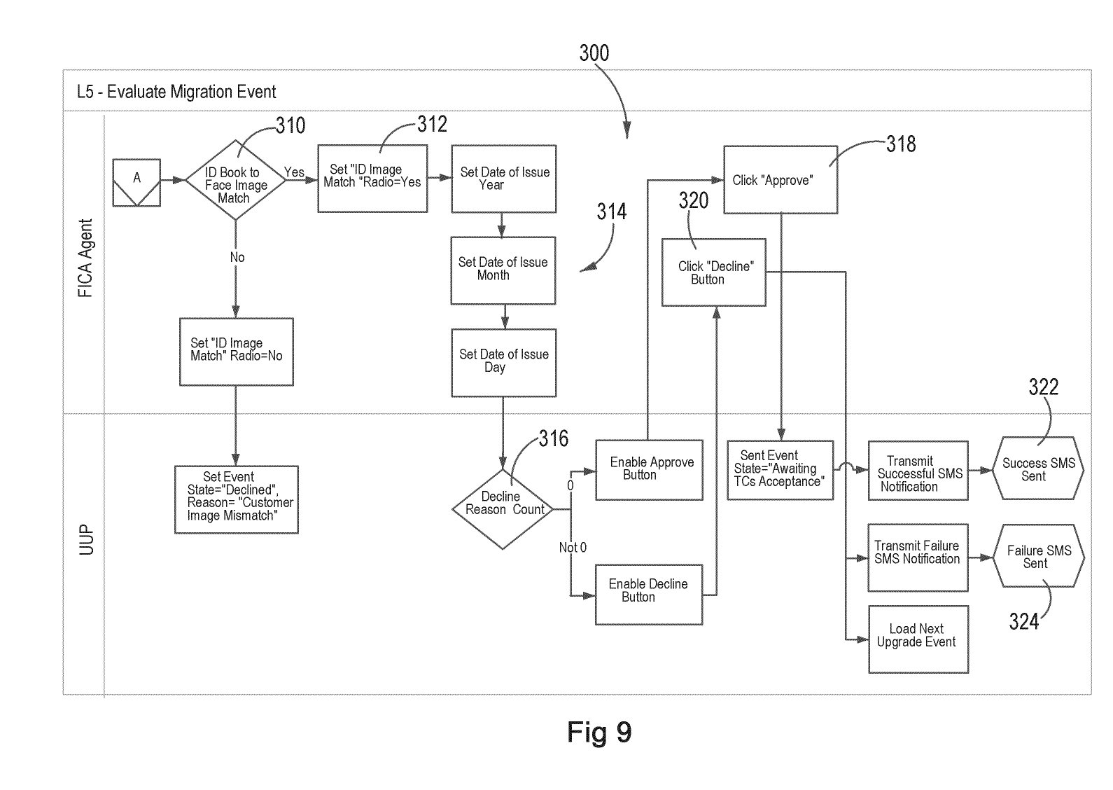

In FIGS. 8 and 9 the step of evaluating the digitized document 300 according to predefined evaluation criteria is shown. At 302, a first image (of the customer holding his/her ID book) is verified for suitability. If suitable, a second image (of the customer ID book) is verified for suitability. At 306 the data on the ID book is compared with data that was previously stored for the customer. If the data match the data on the database 22 at 308, the name information is confirmed on the database 22, if not the data is not stored. At 310, the face of the customer is compared to the ID book mage, if the face match, the ID image is set as confirmed at 312 the confirmation date is set at 314. If the verification process was successful at 316, the operator is prompted to approve the verification at 318 and a confirmation SMS is transmitted to the user at 322. If the verification process was unsuccessful at 316, the operator is prompted to decline the application at 320 and a confirmation SMS is transmitted to the user at 324.

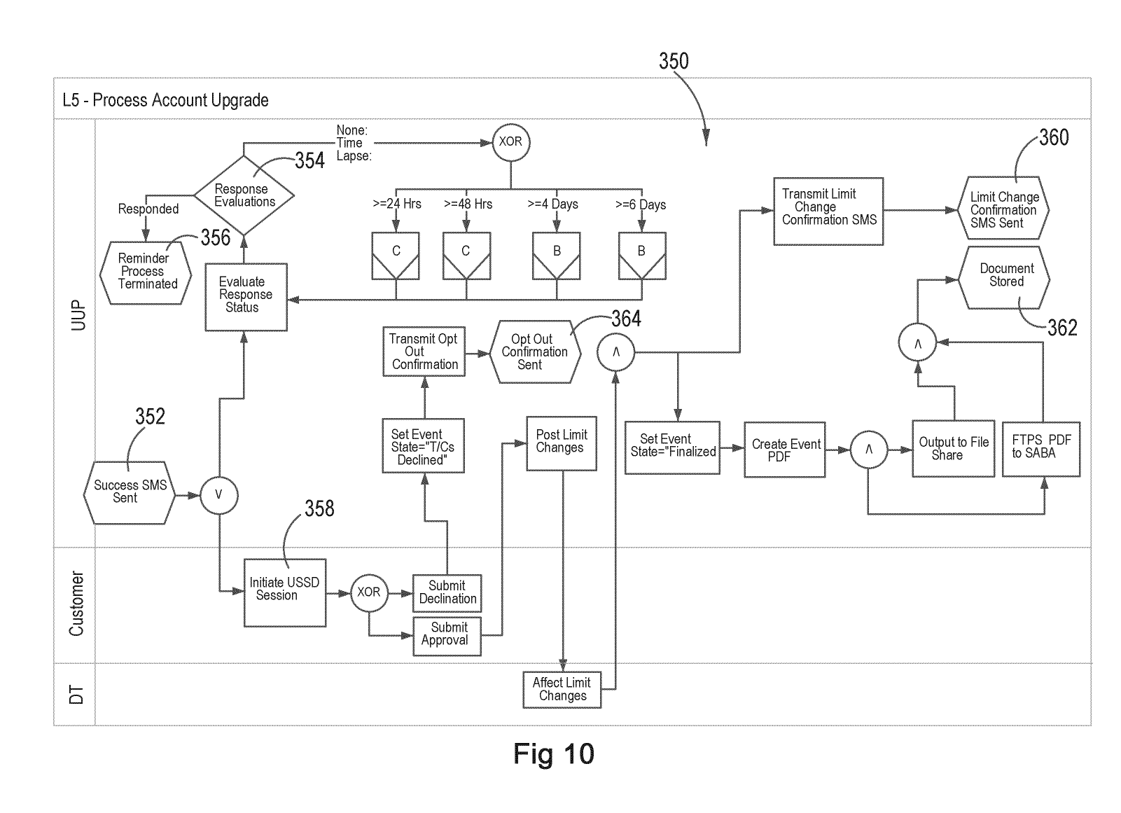

In FIG. 10 the step 350 of requesting a remote receiver to accept certain conditions upon associating the person with a particular set of data is illustrated. At 352, when the association process has been successful, a response is evaluated at 354, and if a response has not been received for a predefined period of time the reminder process is terminated at 356. At 358 a USSD session is simultaneously initiated and if approved the process terminates successfully at 360 and the data is stored at 362. If the process terminates unsuccessfully at 364, the method ends without any confirmation being send.

The inventor is of the opinion that the invention provides a new a method of associating a person with a particular set of data and a new personal data association system.

What is claimed is:

1. A method of associating a person with a particular set of data, which method includes,
digitally capturing into a digitized document an image of a trusted document on which the identity of a person is represented on a capturing device;
capturing data with which the person is to be associated on the capturing device;
transmitting the digitized document in combination with the captured data via a computer network from the capturing device to a remote receiver.

2. The method as claimed in claim 1, in which the computer network is any one of a mobile telephone network and the Internet.

3. The method as claimed in claim 1, which includes the step of verifying the identity of an operator of the capturing device.

4. The method as claimed in claim 1, which includes the step of requesting a person to accept certain conditions before transmitting the digitized document in combination with the captured data.

5. The method as claimed in claim 1, in which the step of digitally capturing an image of a trusted document includes capturing the image in combination with the face of the person whose identity is to be verified.

6. The method as claimed in claim 1, which further includes
receiving in digitized format a captured image of a trusted document on which the identity of a person is represented on a server;
receiving captured data with which the person is to be associated on the server;
evaluating the digitized format of the captured image of the trusted document according to predefined evaluation criteria;
storing the captured data in association with the person identified on the digitized format of the captured image of the trusted document if the predefined evaluation criteria is met.

7. The method as claimed in claim 6, in which the trusted document includes further details that are to be verified.

8. The method as claimed in claim 6, in which receiving captured data with which the person is to be associated includes receiving data related to a particular business transaction.

9. The method as claimed in claim 6, in which evaluating the digitized format of the captured image of the trusted document includes comparing the digitized format of the captured image of the trusted document with previous data, which the digitized format of the captured image of the trusted document purports to represent.

10. The method as claimed in claim 6, which includes receiving in digitized format an image taken of a person.

11. The method as claimed in claim 10, in which evaluating the digitized format of the captured image of the trusted document according to predefined evaluation criteria includes comparing the image of the person with the image of the trusted document representing the image of the person.

12. The method as claimed in claim 11 in which evaluating the digitized format of the captured image of the trusted document includes any one of a manual or an automated comparison of the image of the person with the image of the trusted document representing the image of the person.

13. The method as claimed in claim 6, which includes transmitting a message to a remote receiver reporting the outcome of the association process.

14. A personal data association system, which includes
a remote data capturing device, having imaging means for capturing and digitizing an image of a trusted document and having a mobile communications interface for transmitting the digitized image of the trusted document in combination with captured data which is to be associated with a person whose identity is to be verified;
a receiver, operable to receive the digitized image of the trusted document in combination with the captured data with which the person is to be associated; and
a database having data fields to store data represented in the digitized image of the trusted document and captured data with which the person is to be associated.

15-18. (canceled)
